(19) United States
(12) Patent Application Publication
(10) Pub. No.: US 2024/0006984 A1
(43) Pub. Date: Jan. 4, 2024

(54) POWER CONVERTER, MOTOR DRIVER, AND REFRIGERATION CYCLE APPLIED EQUIPMENT

(71) Applicant: Mitsubishi Electric Corporation, Tokyo (JP)

(72) Inventors: Haruka MATSUO, Tokyo (JP); Takaaki TAKAHARA, Tokyo (JP); Koichi ARISAWA, Tokyo (JP); Keisuke UEMURA, Tokyo (JP); Kenji TAKAHASHI, Tokyo (JP)

(21) Appl. No.: 18/254,785

(22) PCT Filed: Jan. 6, 2021
(86) PCT No.: PCT/JP2021/000197

§ 371 Date: May 26, 2023

(51) Int. Cl. H02M 1/14; H02M 7/04; H02M 7/219

(52) U.S. Cl. CPC H02M 1/14; H02M 7/05; H02M 7/219

(57) ABSTRACT

A power converter includes a converter, a smoothing capacitor, an inverter, and a controller. The converter rectifies a power supply voltage applied from an alternating-current power supply. The smoothing capacitor smooths a rectified voltage output from the converter into a direct-current voltage including a ripple. The inverter converts the direct-current voltage smoothed by the smoothing capacitor into an alternating-current voltage to be applied to a motor. The controller performs control such that a first physical quantity representing an operation state of the converter is equal to a second physical quantity representing an operation state of the inverter.

### CROSS REFERENCE TO RELATED APPLICATION

This application is a U.S. national stage application of International Patent Application No. PCT/JP2021/000197 filed on Jan. 6, 2021, the disclosure of which is incorporated herein by reference.

### TECHNICAL FIELD

The present disclosure relates to a power converter that converts alternating-current power into desired power and also relates to a motor driver and a refrigeration cycle applied equipment.

### BACKGROUND

A power converter includes: a converter that rectifies a power supply voltage that is a voltage of an alternating-current power supply; a smoothing capacitor that smooths a rectified voltage output from the converter; and an inverter that converts a direct-current voltage output via the smoothing capacitor into an alternating-current voltage for a load. In other words, the power converter has, between the converter and the inverter, the smoothing capacitor that smooths the voltage output from the converter.

In this type of power converter, power is supplied from the smoothing capacitor to the inverter during a period when the rectified voltage output from the converter is lower than a capacitor voltage that refers to the voltage of the smoothing capacitor. Therefore, a discharge current flows through the smoothing capacitor. During a period when the rectified voltage is higher than the capacitor voltage, the power is supplied from the alternating-current power supply to the inverter. This is when a charge current flows through the smoothing capacitor. In this way, the power converter continuously supplies the power from the inverter to the load.

Smoothing capacitors are generally known to be components having a limited life-span. A capacitor current that refers to the current flowing through the smoothing capacitor is one factor determining the life of the smoothing capacitor. Therefore, if the capacitor current can be reduced, the smoothing capacitor is enabled to have a longer life. However, in order to reduce the capacitor current it is necessary to increase the capacitance of the smoothing capacitor. If the capacitance of the smoothing capacitor increases, higher costs of the smoothing capacitor becomes problematic.

Given such a technical background, Patent Literature 1 cited below describes: a converter circuit that converts alternating-current power into direct-current power; a smoothing capacitor connected in parallel with a direct-current side of the converter circuit; and a power converter that controls a capacitor current flowing through the smoothing capacitor to a set value. In this power converter, a reduced capacitance of the smoothing capacitor is achieved by detecting the capacitor current flowing through the smoothing capacitor and controlling the detected capacitor current to the set value.

### PATENT LITERATURE

Patent Literature 1: Japanese Patent Application Laid-open No. 2006-67754

However, the technique described in Patent Literature 1 is a technique that causes the capacitor current to follow the set value, namely a command value. When the capacitor current is caused to follow the command value, a target value is fixed to zero. In this case, an integral (I) controller is required for a controller to follow and converge to the target value, which is the fixed value. However, in the cases of the capacitor current cannot be made zero due to a load or an environment during operation, output of the I controller increases to become saturated, and the control accuracy may become degraded.

### SUMMARY

The present disclosure has been made in view of the above, and an object of the present disclosure is to obtain a power converter adapted to avoid occurrences of degradation of control accuracy and control failure while enabling reduced capacitance of a smoothing capacitor.

In order to solve the above-stated problems and achieve the object, a power converter according to the present disclosure includes a converter, a smoothing capacitor, an inverter, and a controller. The converter is adapted to rectify a power supply voltage applied from an alternating-current power supply. The smoothing capacitor is adapted to smooth a rectified voltage output from the converter into a direct-current voltage including a ripple. The inverter is adapted to convert the direct-current voltage smoothed by the smoothing capacitor into an alternating-current voltage for a motor. The controller is adapted to control such that a first physical quantity representing an operation state of the converter is equal to a second physical quantity representing an operation state of the inverter.

The power converter according to the present disclosure has effects of avoiding occurrences of degradation of control accuracy and control failure and enabling reduced capacitance of the smoothing capacitor.

### BRIEF DESCRIPTION OF DRAWINGS

FIG. 1 is a diagram illustrating a configuration example of a power converter according to a first embodiment.

FIG. 2 is a diagram illustrating a configuration example of a converter current control system according to the first embodiment.

FIG. 3 is a diagram illustrating a first configuration example of a pulsation compensation block in the converter current control system according to the first embodiment.

FIG. 4 is a diagram illustrating a second configuration example of the pulsation compensation block in the converter current control system according to the first embodiment.

FIG. 5 is a diagram illustrating a configuration example of an inverter current control system according to the first embodiment.

FIG. 6 is a diagram illustrating a first configuration example of a pulsation compensation block in the inverter current control system according to the first embodiment.

FIG. 7 is a diagram illustrating a second configuration example of the pulsation compensation block in the inverter current control system according to the first embodiment.

FIG. 8 is a diagram illustrating a configuration example of a power converter according to a modification of the first embodiment.

FIG. 9 is a first diagram that is used for describing a control technique according to a second embodiment.

FIG. 10 is a second diagram that is used for describing the control technique according to the second embodiment.

FIG. 11 is a third diagram that is used for describing the control technique according to the second embodiment.

FIG. 12 is a first diagram that is used for describing a processing technique according to a third embodiment.

FIG. 13 is a second diagram that is used for describing the processing technique according to the third embodiment.

FIG. 14 is a diagram illustrating a configuration example of a refrigeration cycle applied equipment according to a fourth embodiment.

### DETAILED DESCRIPTION

With reference to the accompanying drawings, a detailed description is hereinafter provided of power converters, a motor driver, and a refrigeration cycle applied equipment according to embodiments of the present disclosure.

### First Embodiment

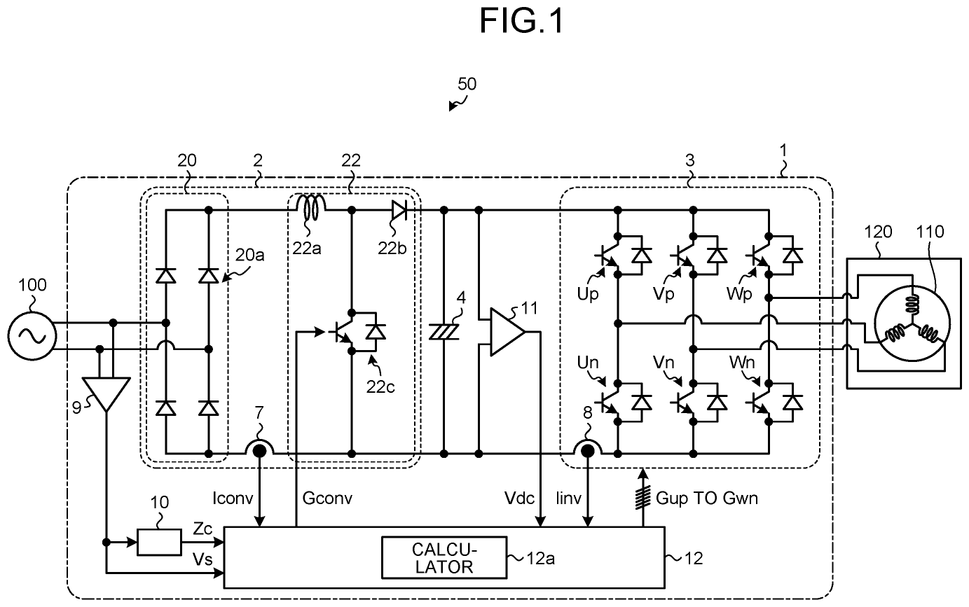

FIG. 1 is a diagram illustrating a configuration example of a power converter 1 according to a first embodiment. The power converter 1 is connected to an alternating-current power supply 100 and a compressor 120. The compressor 120 is an example of a load having periodic load torque variations. The compressor 120 includes a motor 110. The power converter 1 converts a power supply voltage applied from the alternating-current power supply 100 into an alternating-current voltage having a desired amplitude and a desired phase and applies the alternating-current voltage to the motor 110.

The power converter 1 includes: a converter 2; an inverter 3; a smoothing capacitor 4; a controller 12; voltage detectors 9 and 11; and a zero crossing detector 10. The power converter 1 and the motor 110 included in the compressor 120 constitute a motor driver 50.

The voltage detector 9 detects the power supply voltage Vs applied to the converter 2 from the alternating-current power supply 100. The zero crossing detector 10 generates a zero crossing signal Zc in accordance with the power supply voltage Vs of the alternating-current power supply 100. The zero crossing signal Zc is, for example, a signal that outputs a “High” level when the power supply voltage Vs is of positive polarity and outputs a “Low” level when the power supply voltage Vs is of negative polarity. These levels may be reversed. A detection value of the power supply voltage Vs and the zero crossing signal Zc are input to the controller 12.

The converter 2 includes a rectifier 20 and a booster 22. The rectifier 20 includes four rectifier elements 20a connected in a bridge configuration. The rectifier 20 rectifies the power supply voltage Vs applied from the alternating-current power supply 100. The booster 22 is connected to output terminals of the rectifier 20. The booster 22 boosts a rectified voltage output from the rectifier 20 and applies the boosted voltage to the smoothing capacitor 4. In the example of FIG. 1, the alternating-current power supply 100 is a single-phase power supply. In the cases where the alternating-current power supply 100 is a three-phase power supply, six rectifier elements 20a are used. In the cases of the alternating-current power supply 100 is the three-phase power supply, how the rectifier elements 20a are arranged and connected is publicly known and is not described here.

The booster 22 includes a reactor 22a, a rectifier element 22b, and a semiconductor switching element 22c. In the booster 22, the semiconductor switching element 22c turns on or off under control of a drive signal Gconv that is output from the controller 12. When the semiconductor switching element 22c is controlled to be turn-on, the rectified voltage is short-circuited via the reactor 22a. This operation is referred to as “power supply short-circuiting operation”. When the semiconductor switching element 22c is controlled to be turn-off, the rectified voltage is applied to the smoothing capacitor 4 via the reactor 22a and the rectifier element 22b. This operation refers to normal rectification operation. If the reactor 22a has stored energy at this time, the rectified voltage and a voltage generated across the reactor 22a add up and are applied to the smoothing capacitor 4.

The booster 22 boosts the rectified voltage by alternately repeating the power supply short-circuiting operation and the rectification operation. These operations are referred to as “boost operation”. The boost operation boosts a voltage between both ends of the smoothing capacitor 4 to a voltage higher than the power supply voltage Vs. Moreover, the boost operation improves a power factor of a power supply current that is a current flowing between the alternating-current power supply 100 and the converter 2. In other words, boost control that causes the booster 22 to perform the boost operation is performed in the first embodiment to boost the rectified voltage and improve the power factor of the power supply current. This control enables a waveform of the power supply current to approximate a sine wave.

The smoothing capacitor 4 is connected between output terminals of the converter 2. The smoothing capacitor 4 smooths the rectified voltage output from the converter 2 into a direct-current voltage including a ripple. Examples of the smoothing capacitor 4 include an electrolytic capacitor and a film capacitor, among others.

The voltage that is generated across the smoothing capacitor 4 has, rather than a full-wave rectified waveform of the alternating-current power supply 100, a waveform including a direct-current component with voltage ripple based on a frequency of the alternating-current power supply 100 superimposed but does not pulsate significantly. A main frequency component of this voltage ripple is a component that is double the frequency of the power supply voltage Vs when the alternating-current power supply 100 is the single-phase power supply or six times the frequency of the power supply voltage Vs when the alternating-current power supply 100 is the three-phase power supply. If the power input from the alternating-current power supply 100 and the power that is output from the inverter 3 do not change, amplitude of this voltage ripple is determined by capacitance of the smoothing capacitor 4. However, as stated above, the power converter according to the present disclosure avoids increased capacitance for a restrained increase in costs of the smoothing capacitor 4. Therefore, a certain degree of voltage ripple is generated in the smoothing capacitor 4. For example, the voltage across the smoothing capacitor 4 becomes the voltage that pulsates in a range such that the voltage ripple has a maximum value smaller than twice its minimum value.

The voltage detector 11 is provided across the smoothing capacitor 4. The voltage detector 11 detects a capacitor voltage Vdc that is the voltage across the smoothing capacitor 4. A detection value of the capacitor voltage Vdc is input to the controller 12.

The inverter 3 is connected across the smoothing capacitor 4. The inverter 3: includes semiconductor switching elements Up, Un, Vp, Vn, Wp, and Wn connected in a three-phase bridge configuration. A reflux diode is connected across and in antiparallel with each of the semiconductor switching elements. In the inverter 3, the semiconductor switching elements Up to Wn turn on or off under control of drive signals Gup to Gwn that are output from the controller 12. The inverter 3: turns on or turns off the semiconductor switching elements Up to Wn; and converts the direct-current voltage, smoothed by the smoothing capacitor 4, into the alternating-current voltage for supplying to the motor 110.

A current detector 7 detects a converter current Iconv that is a current flowing in the converter 2. The converter current Iconv is also the current flowing between the rectifier 20 and the booster 22. A current detector 8 detects an inverter current Iinv that is a current flowing in the inverter 3. The inverter current Iinv is also the current flowing between the inverter 3 and the smoothing capacitor 4. The converter current Iconv and the inverter current Iinv are input to the controller 12.

The compressor 120 is the load that includes the motor 110. The load is, for example, included in an air conditioner. In the cases where the motor 110 serves as a motor that drives a compression mechanism, the motor 110 rotates according to the amplitude and the phase of the alternating-current voltage applied from the inverter 3, performing a compression operation.

The controller 12 includes a calculator 12a as a computing means. The calculator 12a is, for example, a microcomputer but may be another computing means referred to as a central processing unit (CPU), a microprocessor, a digital signal processor (DSP), or the like. The calculator 12a performs operation controls on the converter 2 and the inverter 3. The drive signals Gconv and Gup to Gwn that are output from the controller 12 are computed and generated by the single calculator 12a. In other words, control computations to control the operations of the converter 2 and the inverter 3 are performed by the single and common calculator 12a included in the controller 12.

The power converter 1 according to the first embodiment controls flow of an appropriate current into the motor 110 by having the semiconductor switching element 22c included in the booster 22 or the semiconductor switching elements Up to Wn included in the inverter 3 driven with appropriate timing. This control is performed on the basis of a detection value of the converter current Iconv that is detected by the current detector 7 and a detection value of the inverter current Iinv that is detected by the current detector 8.

A typical power converter includes a converter control system that controls a bus voltage to a desired value. The bus voltage is a voltage between the direct-current bus lines to which the smoothing capacitor 4 is connected. This type of converter control system performs the control on the basis of the detection value detected by the current detector 7. Moreover, in the typical power converter, and in the power converter of sensorless control having no position sensor or no speed sensor includes an inverter control system that controls speed of the motor 110. According to this type of inverter control system, the control is performed based on the detection value detected by the current detector 8, because the control is performed for causing an estimated speed value estimated in the control system to match a speed command value. In other words, the power converter 1 according to the first embodiment uses the detection values obtained from the existing current detectors 7 and 8 in controlling the converter 2 or the inverter 3.

The converter current Iconv is an example of a physical quantity representing an operation state of the converter 2, and the inverter current Iinv is an example of a physical quantity representing an operation state of the inverter 3. In the present description, in order to distinguish these two physical quantities from each other, the physical quantity representing the operation state of the converter 2 may be described as the “first physical quantity”, and the physical quantity representing the operation state of the inverter 3 may be described as the “second physical quantity”. It is to be noted that other physical quantities may be used instead of the above described physical quantities. Another example of the first physical quantity is power that is exchanged between the converter 2 and the smoothing capacitor 4. Another example of the second physical quantity is power that is exchanged between the smoothing capacitor 4 and the inverter 3

A description is provided next of configurations and operations of essential parts of the power converter 1 according to the first embodiment. A current that flows through the smoothing capacitor is hereinafter denoted by “Ic”.

First, when the semiconductor switching element 22c of the booster 22 does not conduct, a relation of the capacitor current Ic, the converter current Iconv, and the inverter current Iinv holds as expressed by Formula (1) below.

Ic=Iconv−Iinv (1)

In above Formula (1), the capacitor current Ic is defined as being of positive polarity in a direction of flow into a positive electrode of the smoothing capacitor 4, namely, in a charge current direction. The converter current Iconv is defined as being of positive polarity in a direction of current flow from the converter 2 into the smoothing capacitor 4. The inverter current Iinv is defined as being of positive polarity in a direction of current flow from the smoothing capacitor 4 into the inverter 3.

To extend a life of the smoothing capacitor 4, the capacitor current Ic should be reduced. This can be done by causing the converter current Iconv and the inverter current Iinv to equalize each other, as is obvious from above Formula (1). A description is hereinafter provided of a control technique that causes the converter current Iconv and the inverter current Iinv to equalize each other.

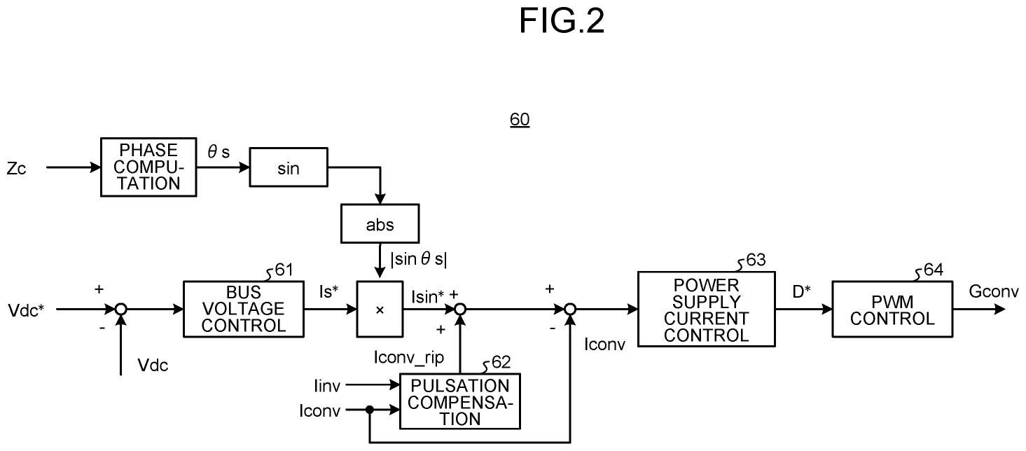

As mentioned above, in the first embodiment, the boost control is performed to boost the rectified voltage and improve the power factor of the power supply current. At this time, in the converter 2, the converter current Iconv, the bus voltage, a phase of the power supply voltage Vs, and another factor determine timing of the turning on and off of the semiconductor switching element 22c. Therefore, a control system illustrated FIG. 2 is conceivable. In other words, FIG. 2 is a diagram illustrating a configuration example of the converter current control system 60 according to the first embodiment.

A description is provided of the operation of the converter current control system 60 illustrated in FIG. 2. In the following description, “Vdc” is described as the bus voltage. In the configuration of FIG. 1, the bus voltage is equal to the capacitor voltage Vdc.

As illustrated in FIG. 2, the converter current control system 60 is configured as a control system that has bus voltage control as a major loop and power supply current control as a minor loop.

In a bus voltage control block 61, a current command value Is* is generated on the basis of a difference between a bus voltage command value Vdc* and the bus voltage Vdc. The bus voltage control block 61 can be configured using, for example, a proportional-integral (PI) controller. A power supply current command value Isin* is generated by multiplying the current command value Is* by an absolute value |sin θs| of a sinusoidal signal sin θs.

θs denotes the phase of the power supply voltage Vs. The phase θs can be determined by phase computation based on the zero crossing signal Zc obtained from the zero crossing detector 10. The phase computation can use a phase lock loop (PLL) process.

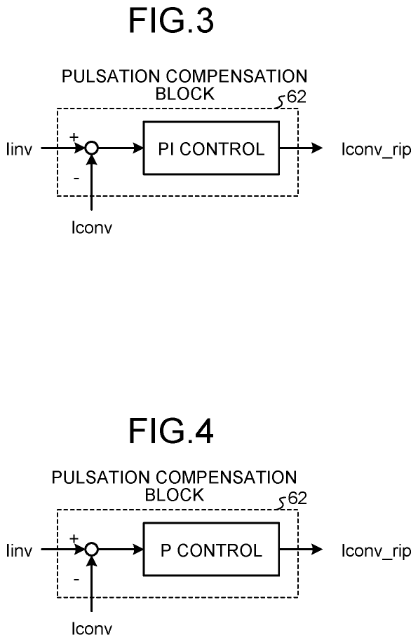

Attention is focused on a pulsation compensation block 62 illustrated in FIG. 2 here. In the pulsation compensation block 62, a compensating amount Iconv_rip of converter current Iconv is computed such that the converter current Iconv equals the inverter current Iinv. FIGS. 3 and 4 illustrate configuration examples of the pulsation compensation block 62. FIG. 3 is a diagram illustrating a first one of the configuration examples of the pulsation compensation block 62 in the converter current control system 60 according to the first embodiment. FIG. 4 is a diagram illustrating a second one of the configuration examples of the pulsation compensation block 62 in the converter current control system 60 according to the first embodiment.

FIG. 3 illustrates a configuration example in which a PI controller is used to control the converter current Iconv as a control target with the inverter current Iinv as a value to be achieved. In the configuration example of FIG. 4, a P controller is used to control the converter current Iconv as the control target with the inverter current Iinv as a value to be achieved. Of course, these controllers are only examples that cause the converter current Iconv to equalize into the inverter current Iinv and are not limiting examples.

Returning to FIG. 2, the compensating amount Iconv_rip of the converter current Iconv is added to the power supply current command value Isin*, and this sum minus the converter current Iconv is input to a power supply current control block 63. The power supply current control block 63 can be configured with a PI controller, too. In the power supply current control block 63, a duty command D* is generated and is input to a PWM control block 64. In the PWM control block 64, the drive signal Gconv is generated.

As described above, in the converter current control system 60 illustrated in FIG. 2, the compensating amount Iconv_rip of converter current Iconv is computed such that the converter current Iconv equals the inverter current Iinv. The semiconductor switching element 22c then turns on or turns off under the control of the pulse-width modulation (PWM) signal so that a desired converter current Iconv is realized taking the compensating amount Iconv_rip into consideration.

The preceding description has been for the control system in which the converter current Iconv is the control target. A description is provided next of the configuration and the operation of a control system in which the inverter current Iinv is a control target. FIG. is a diagram illustrating a configuration example of the inverter current control system 80 according to the first embodiment.

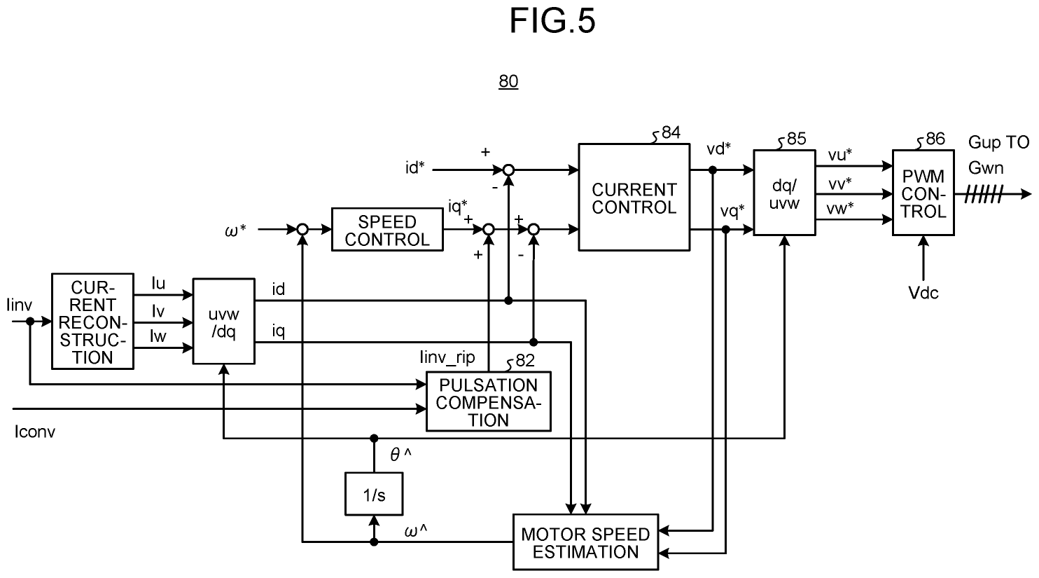

In the inverter current control system 80, as illustrated in FIG. 5, a d-axis and a q-axis current id and iq in a rotating reference frame are computed in order for three phase voltage command values vu*, vv*, and vw* to be generated. The three phase voltage command values vu*, vv*, and vw* refer to command values that are used in voltage application to the motor for rotating the motor 110 at a desired rotational speed. The drive signals Gup to Gwn for the semiconductor switching elements Up to Wn are generated by PWM control for desired d-axis and q-axis currents id and iq to be realized.

Explanations of characters used in FIG. 5 are added here. “Iu, Iv, and Iw” denote current values in a stationary three-phase reference frame. “uvw/dq” denotes a process of converting values in the stationary three-phase reference frame to values in the d-q rotating reference frame; and “dq/uvw” denotes a process of converting values in the d-q rotating reference frame to values in the stationary three-phase reference frame. “id*, iq*, vd*, and vq*” respectively denote a d-axis current command value, a q-axis current command value, a d-axis voltage command value, and a q-axis voltage command value in the d-q rotating reference frame. “ω*, ω\hat{ }, and θ\hat{ }” respectively denote a rotational speed command value, an estimated rotational speed value, and an estimated rotor position of the motor 110.

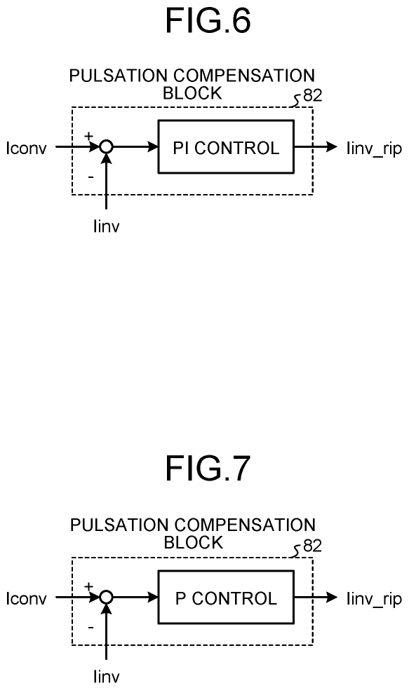

Attention is focused on a pulsation compensation block 82 illustrated in FIG. 5 here. In the pulsation compensation block 82, a compensating amount Iinv_rip of inverter current Iinv is computed such that the inverter current Iinv equals the converter current Iconv. FIGS. 6 and 7 illustrate configuration examples of the pulsation compensation block 82. FIG. 6 is a diagram illustrating a first configuration example of the pulsation compensation block 82 in the inverter current control system 80 according to the first embodiment. FIG. 7 is a diagram illustrating a second configuration example of the pulsation compensation block 82 in the inverter current control system 80 according to the first embodiment.

In the configuration example of FIG. 6, a PI controller is used to control the inverter current Iinv as the control target with the converter current Iconv as a value to be achieved. In the configuration example of FIG. 7, a P controller is used to control the inverter current Iinv as the control target with the converter current Iconv as the value to be achieved. Of course, these controllers are only examples that cause the inverter current Iinv to equalize into the converter current Iconv and are not limiting examples.

Returning to FIG. 5, the compensating amount Iinv_rip of inverter current Iinv is added to the q-axis current command value Iq*, and this sum minus the q-axis current iq is input to a current control block 84. The current control block 84 can be configured with a PI controller, too. The d-axis voltage command value vd* and the q-axis voltage command value vq* are generated in the current control block 84 and converted in a coordinate transformation block 85 to the three phase voltage command values vu*, vv*, and vw* to be input to a PWM control block 86. In the PWM control block 86, the drive signals Gup to Gwn are generated on the basis of the capacitor voltage Vdc.

As described above, in the inverter current control system 80 illustrated in FIG. 5, the compensating amount Iinv_rip of inverter current Iinv is computed such that the inverter current Iinv equals the converter current Iconv. The semiconductor switching elements Up to Wn then turn on or turn off under the control of the PWM signals so that a desired inverter current Iinv is realized taking the compensating amount Iinv_rip into consideration.

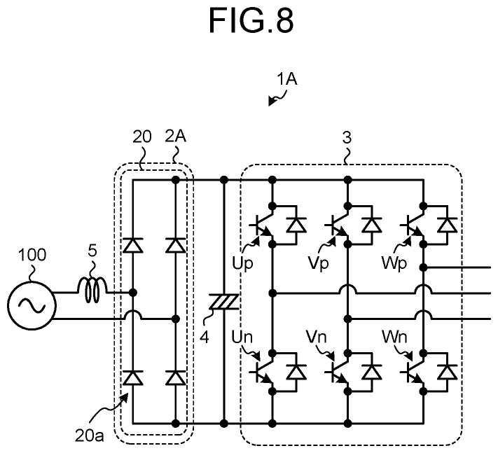

While the converter 2 includes the booster 22 in the configuration example illustrated in FIG. 1, the control according to the first embodiment is not limited to the configuration of FIG. 1. For example, the control according to the first embodiment is also applicable to a power converter 1A illustrated in FIG. 8. FIG. 8 is a diagram illustrating a configuration example of the power converter 1A according to a modification of the first embodiment.

In the power converter 1A illustrated in FIG. 8, the converter 2 is replaced with a converter 2A. The converter 2A is such that the booster 22 is removed from the configuration of FIG. 1, and the reactor 22a of the booster 22 is replaced with a reactor 5 that is disposed between the alternating-current power supply 100 and the rectification unit 20. The configuration is otherwise identical or equivalent to that of the power converter 1 illustrated in FIG. 1, and identical or equivalent constituent elements have the same reference characters.

With the above-described power converter 1A, while switching control cannot be performed on the converter 2A, switching control of the inverter 3 is possible. Therefore, the use of the control technique of the inverter current control system 80 that is included in the above-described control technique according to the first embodiment can provide the above effect.

As described above, in the power converter according to the first embodiment, the controller is adapted to perform the control such that the first physical quantity representing the operation state of the converter is equal to the second physical quantity representing the operation state of the inverter. The present control technique is the technique that controls the first physical quantity, which corresponds to the converter current, and the second physical quantity, which corresponds to the inverter current, rather than using, as in Patent Literature 1, the capacitor current as a target value. Moreover, for the present control technique, the target value is not a fixed value but constantly changes, and as illustrated in FIGS. 4 and 7, integral control is not requisite. Therefore, compared with the control configuration of Patent Literature 1 that requires the integral control, the control configuration is simple, with the degradation of the control accuracy and control failure, too, being less likely. Thus, occurrences of the degradation of the control accuracy and the control failure are avoidable. The present control technique also enables reduced capacitance of the smoothing capacitor, since the certain degree of voltage ripple is allowable across the smoothing capacitor. Furthermore, the present control technique can ideally reduce the capacitor current to zero, thus enabling the smoothing capacitor to have an extended life.

While the compressor has been described above as the example of the load, this is not limiting. The control technique described above is applicable to rotation control of a motor that drives a mechanism with period torque pulsations, not to mention the compressor.

### Second Embodiment

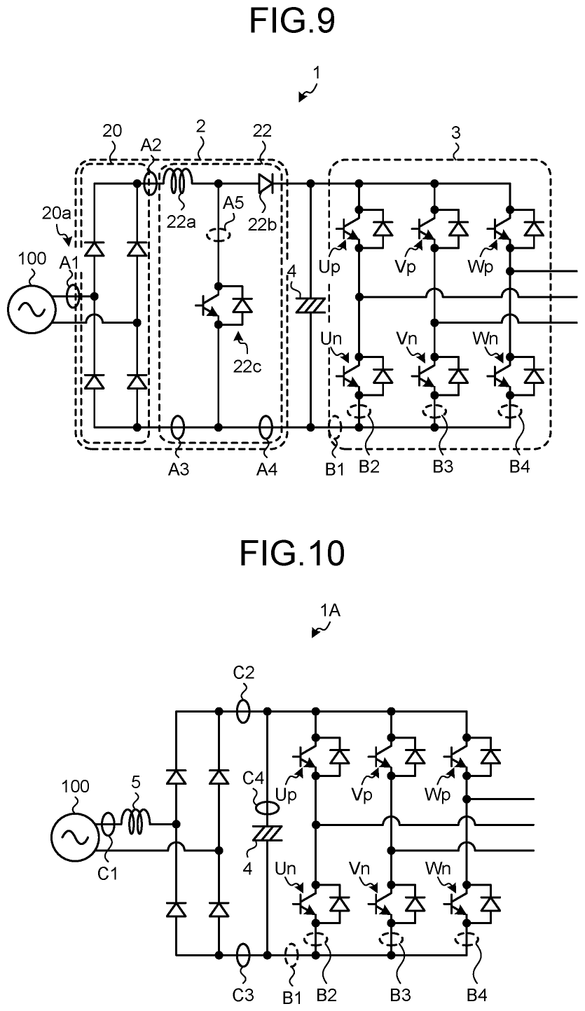

In a second embodiment, a description is provided of timings of detections of the converter current Iconv and the inverter current Iinv. FIG. 9 is a first diagram that is used for describing a control technique according to the second embodiment. FIG. 9, as the circuit diagram of the power converter 1 illustrated in FIG. 1, illustrates plural examples of detection positions where the converter current Iconv and the inverter current Iinv are detected. If a detector for the converter current Iconv is provided at any of positions A1 to A5, the detection of the converter current Iconv is possible. If a detector for the inverter current Iinv is provided at position B1 or at least at two of positions B2 to B4, the detection of the inverter current Iinv is possible.

However, at position A5 indicated by a broken line, the current flows through the detector only when the semiconductor switching element 22c is turned on. For this reason, the timing of the current detection and the timing of the turning on or off of the semiconductor switching element 22c need to be synchronized. In other words, the controller 12 according to the second embodiment needs to detect the converter current Iconv in accordance with timing of conduction or nonconduction of the semiconductor switching element 22c in the converter 2.

At each of positions B2 to B4 indicated by broken lines, the current similarly flows through the detector only when the semiconductor switching element Un, Vn, or Wn associating with the corresponding position is turned on. For this reason, the timing of the current detection and timing of turning on or off of the associating semiconductor switching element need to be synchronized. In other words, the controller 12 according to the second embodiment needs to detect the inverter current Iinv in accordance with timing of conduction or nonconduction of the semiconductor switching element Un, Vn, or Wn in the inverter 3.

FIG. 10 is a second diagram that is used for describing the control technique according to the second embodiment. FIG. 10 is a repetition of the circuit diagram of the power converter 1A illustrated in FIG. 8. In FIG. 10, if a detector for the converter current Iconv is provided at any of positions C1 to C4, the detection of the converter current Iconv is possible. Positions where the inverter current Iinv is detected are the same as in FIG. 9 and are not described here.

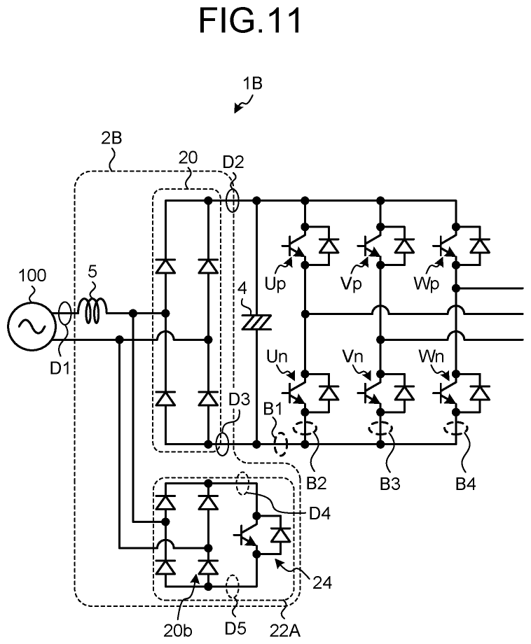

FIG. 11 is a third diagram that is used for describing the control technique according to the second embodiment. FIG. 11 illustrates a configuration example of a power converter 1B different from those in FIGS. 1 and 8.

The power converter 1B illustrated in FIG. 11 includes a converter 2B in place of the converter 2. The converter 2B includes, in place of the booster 22, a booster 22A and a reactor 5. The reactor 5 is disposed between the alternating-current power supply 100 and the rectifier 20. As with the converter 2 illustrated in FIG. 1, the converter 2B is a constituent element having a rectification function and a boost function in combination. The booster 22A includes four rectifier elements 20b and a semiconductor switching element 24. The booster 22A is connected in parallel with the rectifier 20. The configuration is otherwise identical or equivalent to that of the power converter 1 illustrated in FIG. 1, and identical or equivalent constituent elements have the same reference characters.

In FIG. 11, if a detector for the converter current Iconv is provided at any of positions D1 to D5, the detection of the converter current Iconv is possible. However, at position D4 or D5 indicated by a broken line, the current flows through the detector only when the semiconductor switching element 24 is turned on. For this reason, the timing of the current detection and timing of turning on or off of the semiconductor switching element 24 need to be synchronized. In other words, the controller 12 according to the second embodiment detects the converter current Iconv in accordance with timing of conduction or nonconduction of the semiconductor switching element 24 in the converter 2B. Positions where the inverter current Iinv is detected are the same as in FIGS. 9 and 10 and are not described here.

In the typical power converter, detectors are disposed at positions appropriate to a use. The use of the technique according to the second embodiment enables the acquisition of the converter current Iconv and the inverter current Iinv with the appropriate timing, regardless of the positions where the detectors are disposed. Therefore, additional costs for a circuit are suppressed.

### Third Embodiment

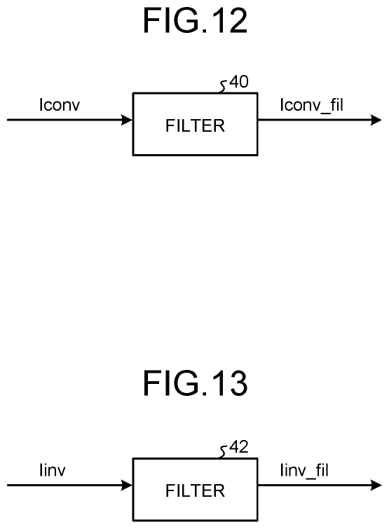

FIGS. 12 and 13 are a first and a second diagram that are used for describing a processing technique according to a third embodiment.

In cases where the semiconductor switching elements 22c and 24 are used to realize boost control or power factor improvement as in the power converters 1 and 1B illustrated in FIGS. 1 and 11, high frequency noise synchronous with a switching cycle of the semiconductor switching element 22c or 24 or each of the semiconductor switching elements Up to Wn is superimposed on the detected converter current Iconv and the detected inverter current Iinv. If, for example, the compensating amount Iconv_rip is computed with the high frequency noise superimposed in the processing within the pulsation compensation block 62 illustrated in each of FIGS. 3 and 4, the converter current Iconv may increase excessively, being affected by the high frequency noise. This leads to an increase in the current that flows into the smoothing capacitor 4.

Therefore, as illustrated in FIG. 12, a detection value of the converter current Iconv is input to a filter 40 in the third embodiment. The filter 40 removes the high frequency noise included in the converter current Iconv to generate a converter current Iconv fil. A fundamental frequency of the converter current Iconv is double the frequency of the power supply voltage Vs and is, for example, 100 Hz or 120 Hz. For this reason, information on frequency components of a band of frequency that are a few kHz and higher, including the high frequency noise, is unnecessary for the control, therefore there is no problem even if the frequency components are filtered out.

Provided the filter 40 is a filter that sufficiently attenuates the high frequency noise synchronous with the switching cycle of the semiconductor switching element 22c or 24, its configurations do not matter. The filter 40 may be configured with a filter circuit that, as an analog circuit, performs filter processing on a signal received from a detector. Instead of being configured this way, the filter 40 may be configured to perform, on the signal that the calculator 12a receives from the detector, filter processing as a digital circuit inside the calculator 12a, that is to say, filter processing as digital processing. The filter 40 may be configured with a low-pass filter or with a notch filter that cancels high frequency components in a specific frequency band.

The above contents are conceivable not only for the converter current Iconv as the control target, but also for the inverter current Iinv as the target value in the control. Therefore, the high frequency noise removal processing is performed even on the inverter current Iinv. Specifically, as illustrated in FIG. 13, a detection value of the inverter current Iinv is input to a filter 42, then the filter 42 is adapted to generate an inverter current Iinv_fil, where the high frequency noise included in the inverter current Iinv is removed.

While the above description has been made for the processing within the pulsation compensation block 62 illustrated in each of FIGS. 3 and 4, the same is conceivable for the processing within the pulsation compensation block 82 illustrated in each of FIGS. 6 and 7. Accordingly, performing the filter processings illustrated in FIGS. 12 and 13 on the converter current Iconv and the inverter current Iinv is preferable in the embodiment.

As described above, the power converter according to the third embodiment includes the filter circuit adapted to perform the filter processing on the first and second physical quantities, and the controller is adapted to control at least one of the converter or the inverter on the basis of outputs of the filter circuit. Thus, an enhanced capacitor current reducing effect is possible, since accurate control of the converter current and the inverter current is enabled.

According to the power converter of the third embodiment, the controller is adapted: to perform the filter processing on detection values of the first and second physical quantities; and to control at least one of the converter or the inverter on the basis of outputs reflecting the filter processing. Thus, an enhanced capacitor current reducing effect is possible, since accurate control of the converter current and the inverter current is enabled.

### Fourth Embodiment

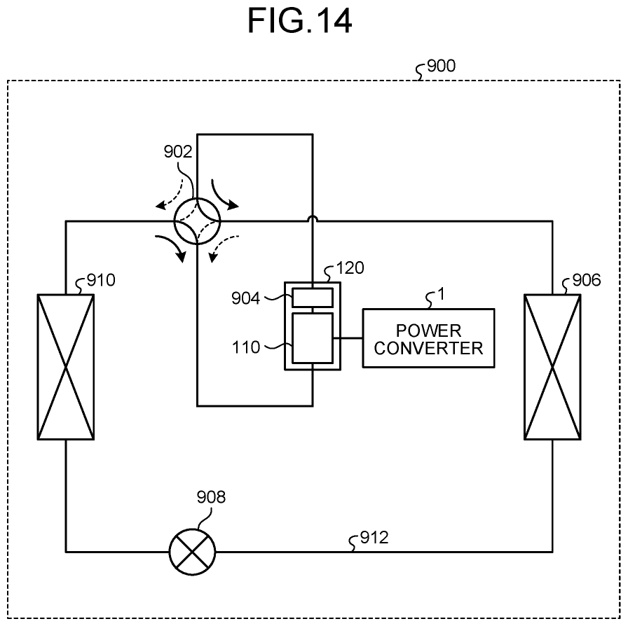

FIG. 14 is a diagram illustrating a configuration example of a refrigeration cycle applied equipment 900 according to a fourth embodiment. The refrigeration cycle applied equipment 900 according to the fourth embodiment includes the power converter 1 described in the first embodiment. The refrigeration cycle applied equipment 900 according to the first embodiment is applicable to a product with a refrigeration cycle, such as an air conditioner, a refrigerator, a freezer, or a heat pump water heater. In FIG. 14, constituent elements with the same functions as those in the first embodiment have the same reference characters as in the first embodiment.

The refrigeration cycle applied equipment 900 has a compressor 120 with a built-in motor 110 of the first embodiment, a four-way valve 902, an indoor heat exchanger 906, an expansion valve 908, and an outdoor heat exchanger 910 connected via refrigerant piping 912.

The compressor 120 internally includes a compression mechanism 904 that compresses a refrigerant and the motor 110 that runs the compression mechanism 904.

The refrigeration cycle applied equipment 900 is capable of operating for heating or cooling through switching operation of the four-way valve 902. The compression mechanism 904 is driven by the motor 110 that is controlled at variable speed.

In the heating operation, as indicated by solid line arrows, the refrigerant is pressurized and discharged by the compression mechanism 904 and returns to the compression mechanism 904 through the four-way valve 902, the indoor heat exchanger 906, the expansion valve 908, the outdoor heat exchanger 910, and the four-way valve 902.

In the cooling operation, as indicated by dashed line arrows, the refrigerant is pressurized and discharged by the compression mechanism 904 and returns to the compression mechanism 904 through the four-way valve 902, the outdoor heat exchanger 910, the expansion valve 908, the indoor heat exchanger 906, and the four-way valve 902.

In the heating operation, the indoor heat exchanger 906 acts as a condenser to release heat, and the outdoor heat exchanger 910 acts as an evaporator to absorb heat. In the cooling operation, the outdoor heat exchanger 910 acts as a condenser to release heat, and the indoor heat exchanger 906 acts as an evaporator to absorb heat. The expansion valve 908 depressurizes and expands the refrigerant.

The described refrigeration cycle applied equipment 900 according to the fourth embodiment includes the power converter 1 described in the first embodiment; however, this is not limiting. The power converter 1A illustrated in FIG. 8 and the power converter 1B illustrated in FIG. 11 may be included instead. In addition, a power converter other than the power converters 1 and 1A may be used, provided that the control technique according to the first embodiment is applicable.

The above configurations illustrated in the embodiments are illustrative, can be combined with other techniques that are publicly known, and can be partly omitted or changed without departing from the gist.

1-10. (canceled)

11. A power converter comprising:
a converter adapted to rectify a power supply voltage applied from an alternating-current power supply;
a smoothing capacitor adapted to smooth a rectified voltage output from the converter into a direct-current voltage containing a ripple;
an inverter adapted to convert the direct-current voltage smoothed by the smoothing capacitor into an alternating-current voltage to be applied to a motor; and
a controller adapted to control such that a first physical quantity is equal to a second physical quantity, the first physical quantity representing an operation state of the converter and the second physical quantity representing an operation state of the inverter, wherein
the controller is adapted to control the inverter such that the second physical quantity is equal to the first physical quantity.

12. A power converter comprising:
a converter adapted to rectify a power supply voltage applied from an alternating-current power supply;
a smoothing capacitor adapted to smooth a rectified voltage output from the converter into a direct-current voltage containing a ripple;
an inverter adapted to convert the direct-current voltage smoothed by the smoothing capacitor into an alternating-current voltage to be applied to a motor; and
a controller adapted to control such that a first physical quantity is equal to a second physical quantity, the first physical quantity representing an operation state of the converter and the second physical quantity representing an operation state of the inverter, wherein
the controller is adapted to control the inverter such that the second physical quantity is equal to the first physical quantity, wherein
the controller is adapted to detect the second physical quantity in accordance with timing of conduction or nonconduction of a semiconductor switching element included in the inverter.

13. A power converter comprising:
a converter adapted to rectify a power supply voltage applied from an alternating-current power supply;
a smoothing capacitor adapted to smooth a rectified voltage output from the converter into a direct-current voltage containing a ripple;
an inverter adapted to convert the direct-current voltage smoothed by the smoothing capacitor into an alternating-current voltage to be applied to a motor;
a controller adapted to control such that a first physical quantity is equal to a second physical quantity, the first physical quantity representing an operation state of the converter and the second physical quantity representing an operation state of the inverter; and
a filter circuit adapted to perform filter processing on the first physical quantity and the second physical quantity, wherein
the controller is adapted to control at least one of the converter or the inverter on a basis of outputs of the filter circuit.

14. A power converter comprising:
a converter adapted to rectify a power supply voltage applied from an alternating-current power supply;
a smoothing capacitor adapted to smooth a rectified voltage output from the converter into a direct-current voltage containing a ripple;
an inverter adapted to convert the direct-current voltage smoothed by the smoothing capacitor into an alternating-current voltage to be applied to a motor; and
a controller adapted to control such that a first physical quantity is equal to a second physical quantity, the first physical quantity representing an operation state of the converter and the second physical quantity representing an operation state of the inverter, wherein the controller is adapted to:
perform filter processing on a detection value of the first physical quantity and a detection value of the second physical quantity; and
control at least one of the converter or the inverter on a basis of outputs reflecting the filter processing.

15. The power converter according to claim 11, wherein
the controller is adapted to control the converter such that the first physical quantity is equal to the second physical quantity.

16. The power converter according to claim 12, wherein
the controller is adapted to control the converter such that the first physical quantity is equal to the second physical quantity.

17. The power converter according to claim 13, wherein
the controller is adapted to control the converter such that the first physical quantity is equal to the second physical quantity.

18. The power converter according to claim 14, wherein
the controller is adapted to control the converter such that the first physical quantity is equal to the second physical quantity.

19. The power converter according to claim 11, wherein
the converter includes at least one semiconductor switching element.

20. The power converter according to claim 12, wherein
the converter includes at least one semiconductor switching element.

21. The power converter according to claim 13, wherein
the converter includes at least one semiconductor switching element.

22. The power converter according to claim 14, wherein
the converter includes at least one semiconductor switching element.

23. The power converter according to claim 19, wherein
the controller is adapted to detect the first physical quantity in accordance with timing of conduction or nonconduction of the semiconductor switching element included in the converter.

24. The power converter according to claim 20, wherein
the controller is adapted to detect the first physical quantity in accordance with timing of conduction or nonconduction of the semiconductor switching element included in the converter.

25. The power converter according to claim 21, wherein
the controller is adapted to detect the first physical quantity in accordance with timing of conduction or nonconduction of the semiconductor switching element included in the converter.

26. The power converter according to claim 22, wherein
the controller is adapted to detect the first physical quantity in accordance with timing of conduction or nonconduction of the semiconductor switching element included in the converter.

27. A motor driver comprising the power converter according to claim 11.

28. A motor driver comprising the power converter according to claim 12.

29. A motor driver comprising the power converter according to claim 13.

30. A motor driver comprising the power converter according to claim 14.

31. A refrigeration cycle applied equipment comprising the power converter according to claim 11.

32. A refrigeration cycle applied equipment comprising the power converter according to claim 12.

33. A refrigeration cycle applied equipment comprising the power converter according to claim 13.

34. A refrigeration cycle applied equipment comprising the power converter according to claim 14.
